(19) United States
(12) Patent Application Publication
(10) Pub. No.: US 2008/0021657 A1
(43) Pub. Date: Jan. 24, 2008

(54) UTILIZING RAPID WATER DISPLACEMENT DETECTION SYSTEMS AND SATELLITE IMAGERY DATA TO PREDICT TSUNAMIS

(75) Inventors: Judy L. Barkal, SWISHER, IA (US); NEIL A. KATZ, PARKLAND, FL (US)

Correspondence Address: PATENTS ON DEMAND, P.A., 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/459,262

(22) Filed: Jul. 21, 2006

(51) Int. Cl. G06F 19/00; G06F 17/40

(52) U.S. Cl. 702/14; 702/187; 702/1; 702/2; 702/127; 702/189; 382/100; 382/108; 382/109

(57) ABSTRACT

One aspect of the present invention can include a method for detecting tsunamis that can include a step of detecting a location of a rapid water displacement event occurring in an ocean, such as an underground Earthquake. Images can be captured proximate to the event utilizing a satellite. The captured images can be analyzed to detect and/or track a tsunami.

### BACKGROUND

1. Field of the Invention

The present invention relates to the field of tsunami detection, and, more particularly, to utilizing rapid water displacement detection systems and satellite imagery data to predict and track tsunamis.

2. Description of the Related Art

A tsunami is an ocean wave or series of waves with a long period that results when a body of water, such as an ocean, is rapidly displaced on a massive scale. Tsunami forming events include underwater Earthquakes, landslides, volcanic eruptions, and meteorite impacts. A conventional solution for detecting tsunamis consists of a network of accurate, deep water pressure sensors called tsunameters that are connected to surface buoys, such as those used by the Deep Ocean Assessment and Reporting of Tsunamis (DART) project. The buoys transmit information via satellite to ground stations. The ground stations utilize this water pressure data to track tsunamis. When a tracked tsunami is predicted to impact a populated coastline, that coastline can be evacuated to save substantial lives, which would otherwise be lost.

Unfortunately, creating, deploying, and maintaining a network of tsunameters, buoys, and ground stations can be expensive. So expensive, that in 2004 the Indian Ocean and the Atlantic Ocean lacked a tsunami monitoring infrastructure. Since tsunamis rarely occur outside the Pacific Ocean, the lack of a robust tsunami detection system was previously not considered a priority for these regions. This perspective has recently changed due to the 2004 Indian Ocean Tsunami, which killed over 300,000 people.

### SUMMARY OF THE INVENTION

A tsunami detection and tracking system that does not rely upon an expensive infrastructure of tsunameters, buoys, and ground stations, which is capable of detecting tsunamis worldwide. The present invention relies upon a combination of satellite imaging technologies and seismic and ionosphere disturbance detection technologies that are to be integrated and repurposed for tsunami detection and tracking purposes. Since tsunamis result from significant events that rapidly displace a large volume of water, tsunamis are relatively easy to detect. For example, the Earthquake of Dec. 26, 2004 that resulted in the Indian Ocean Tsunami was detected and world-wide crisis centers were properly notified. Technologies at that time were not, however, able to detect and track the tsunami that resulted from the underwater Earthquake.

In more detail, the present invention can utilize existing detection systems and technologies to detect rapid water displacement events and the location of the same. Detection of these events can involve detecting seismic activity and/or detecting ionosphere disturbances. Once a rapid water displacement event is detected, a trigger event can be sent to satellite imaging systems to ensure that the area about the event is observed. Satellite obtained images can be analyzed to predict wave heights, speed, wave period, and direction of a potential tsunami. If a relatively high likelihood of a tsunami exists, one or more satellites can be automatically repositioned, if necessary, to ensure proper area coverage. An advantage of using satellites in this fashion is that these satellites are already deployed for numerous purposes including ocean monitoring and research. Additionally, satellite imagery tsunami detection techniques can be combined with traditional tsunameter-based detection to increase tsunami detection accuracy and to provide earlier tsunami warnings than is possible at present using conventional tsunameter-based systems.

The present invention can be implemented in accordance with numerous aspects consistent with material presented herein. For example, one aspect of the present invention can include a method for detecting tsunamis and can include a step of detecting a location of a rapid water displacement event occurring in an ocean. Images can be captured proximate to the event utilizing a satellite. The captured images can be analyzed to detect and/or track a tsunami.

Another aspect of the present invention can include a system for detecting tsunamis that includes a rapid water detection system, an imaging satellite, and an image analyzer. The rapid water displacement detection system can detect an occurrence and a location of events that result in rapid water displacements occurring in an ocean. The imaging satellite can capture images of areas indicated by the detection system responsive to a detected rapid water displacement event. The image analyzer can analyze the images captured by the imaging satellite to ascertain wave height, wave speed, wave period, and wave direction for waves resulting from the detected rapid water displacement event. An existence of a tsunami can be determined based upon the ascertained wave height, wave speed, and wave direction.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

It should also be noted that the methods detailed herein can also be methods performed at least in part by a service agent and/or a machine manipulated by a service agent in response to a service request.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a tsunami detection and tracking system in accordance with an embodiment of the inventive arrangements disclosed herein.

FIG. 2 is a method for detecting tsunamis in accordance with an embodiment of the inventive arrangements disclosed herein.

FIG. 3 is a flow chart of a method, where a service agent can configure a system that detects and/or tracks tsunamis based upon satellite images in accordance with an embodiment of the inventive arrangements disclosed herein.

### DETAILED DESCRIPTION OF THE INVENTION

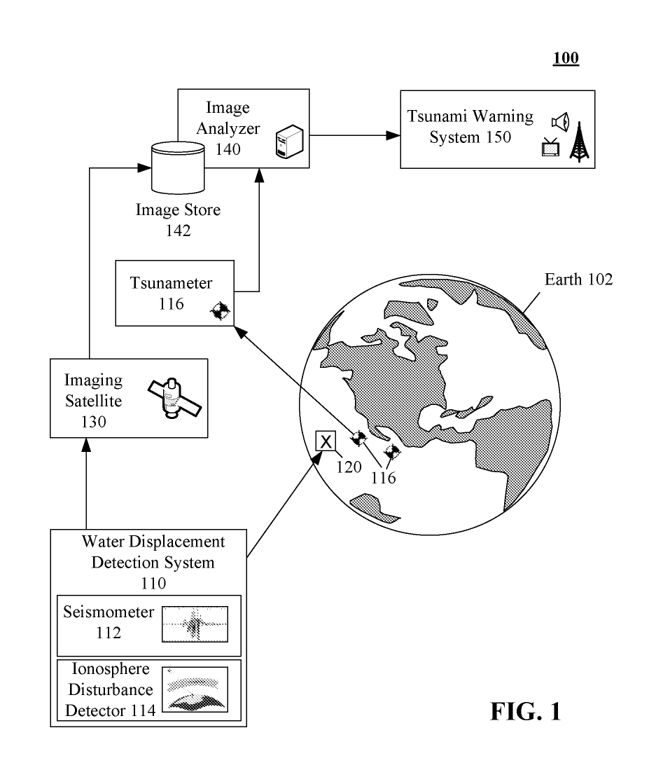

FIG. 1 is a schematic diagram of a tsunami detection and tracking system 100 in accordance with an embodiment of the inventive arrangements disclosed herein. The system 100 includes a water displacement detection system 110 that can detect and locate a water displacement event 120 occurring on the Earth 102.

A water displacement event 120 can be any event occurring in the ocean that results in a large volume of water being rapidly displaced. Water displacement events 120 have potential to result in a tsunami. Examples of water displacement events include, but are not limited to, underwater Earthquakes, landslides, volcanic eruptions, meteorite impacts, and the like.

The rapid water displacement detection system 110 can include seismometer 112 and ionosphere disturbance detector 114. A seismometer 112 also called a seismograph can be used to measure and record seismic waves. Seismometer 112 can be used to measure and locate Earthquakes and other ground motions, including those occurring under the ocean.

The ionosphere disturbance detector 114 can take advantage of a fact that Earthquakes create acoustic waves that perturb the ionosphere. The ionosphere is an atmospheric region filled with charged particles that blankets the Earth 102 between altitudes of about 75 to 1000 km. The ionosphere has an ability to interfere with radio waves propagating through it. Thus, radio waves conveyed through the ionosphere to satellites, such as Global Positioning Satellites (GPS), can be used to detect ionosphere disturbances. Because multiple GPS satellites are within range of any Earth-side position at any one time, triangulation can be used to detect locations of ionosphere disturbances. These disturbances can occur both before and after an Earthquake, which grants users an ability to predict Earthquakes before they actually occur. Ionosphere disturbance detectors 114 can include specific purposed devices, such as the Detection of Electro-Magnetic Emissions Transmitted from Earthquake Regions (DEMETER) that is a MYRIADE class satellite by the Centre National d'Études Spatiales (CNES) having a specific purpose of detecting ionosphere disturbances.

Once the water displacement detection system 110 has detected event 120, one or more imaging satellites 130 can be notified to ensure that captured images of the region about the event 120 are obtained. Imaging satellites 130 can include a variety of preexisting and planned satellites and satellite constellations, such as satellites included in the Global Earth Observing System of System (GEOSS) project. The images obtained from imaging satellite 130 can be combined with other aerial images, such as those taken from planes or the ground.

These images can be stored in an image store 142 and analyzed with image analyzer 140. Satellites 130 can be optically focused to zoom in on a particular region, such as the region about event 120 after a detection of the event 120 to capture detailed images for tsunami detection purposes. These images can be digitally processed by the image analyzer 140 using a myriad of known image enhancement techniques and wave models.

For example, analyzed images in the image store 142 can be used in accordance with wave models, such as the WAM model by the Development and Implementation Group and the National Oceanic and Atmospheric Association (NOAA)'s Wavewatch III Wave Model, to calculate wave direction, wave height, wave speed, wave period, and other wave characteristics. A tsunami can be detected, monitored, and/or tracked based upon the wave characteristics discerned from the analyzed images. It should be understood that each of these models and techniques used for wave tracking/prediction can be combined with other data points, such as wind and data from tsunameters 116 to increase accuracy of predictions.

A tsunameter 116 is a system including a sophisticated pressure gauge set on the ocean floor that sends signals to a surface buoy, which in turn transmits pressure data to a satellite. The satellite sends the pressure data to a pressure analyzer which can determine ocean waves based upon the pressure readings. Unlike satellite images, which can be used to detect waves and wave patterns occurring in the deep ocean, tsunameters 116 are generally dispersed along a coast-line as an early warning system for tsunamis. Combining satellite image based tsunami detection techniques with pressure based techniques can result in earlier warnings and more accurate tsunami predictions than is possible using conventional techniques alone. Additionally, image based tsunami detection systems do not require the deployment and maintenance of a water pressure detection infrastructure, which is currently unavailable in many areas such as the Indian Ocean.

It should be appreciated that information from additional data sources (besides that gathered by tsunameter 116) can be combined with information obtained from imaging satellite 130 and processed by analyzer 140 to increase tsunami prediction accuracy. For example, data obtained from eye-witness sightings, animal/natural behavior changes, atmospheric changes, weather pattern changes, and the like can be used by system 100 to increase tsunami detection and tracking accuracy.

Once a potential tsunami has been detected based at least in part on satellite images analyzed by image analyzer 140, a warning can be broadcasted using a tsunami warning system 150. The warning system 150 can include an emergency response system of a country or area where the tsunami is expected to hit. The warning system 150 can include radio, television, Internet, local sirens, telephone, and other communications designed to warn a population of the tsunami threat. The warning system 150 can also trigger local, governmental, and/or international emergency evacuation/preparation efforts related to a detected tsunami threat.

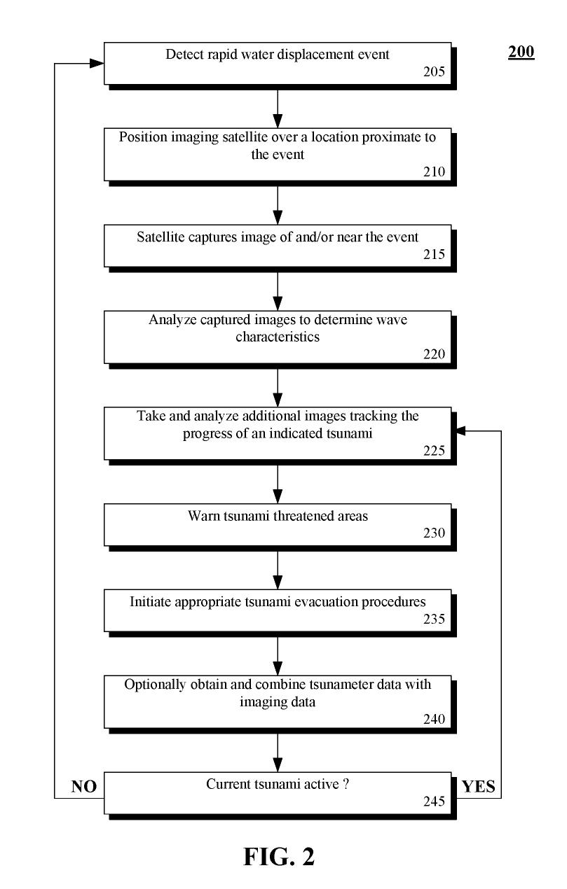

FIG. 2 is a method 200 for detecting tsunamis in accordance with an embodiment of the inventive arrangements disclosed herein. Method 200 can be performed in the context of a system 100, or any system that detects tsunamis by analyzing satellite images.

Method 200 can begin in step 205, where a rapid water displacement event can be detected and/or predicted. Rapid water displacement events can include underwater Earthquakes, landslides, volcanic eruptions, meteorite impacts and the like. Detection can occur through any of a variety of means including, but not limited to, seismograph readings, detections of ionosphere disturbances, detections of meteorites, and the like. In step 210, a satellite can be positioned over the location where the event was detected and/or predicted. The satellite can be part of a constellation of satellites specifically tasked with monitoring weather, oceans, and the like. The satellite can also be a satellite normally dedicated to another purpose that is automatically repurposed and/or repositioned responsive to the detected rapid water displacement event.

In step 215, the satellite can capture images of the event and/or proximate to the event. In step 220, the captured images can be analyzed to determine wave heights, wave speeds, wave directions, and/or wave periods for any waves resulting from the event. An existence of a tsunami can be detected based upon this analysis since tsunami waves have unique characteristics. For example, a wave period from crest to crest for a tsunami typically has a period between ten to thirty minutes, which is much longer than other significant ocean waves. Long swells, for instance, typically have fifteen to twenty second periods.

It should be appreciated that archived images can be analyzed to determine wave characteristics proximate to an event, after the event has occurred in situations where the event is not predicted ahead of time and where images of the area proximate to the event have been taken. Otherwise, a relatively wide area about the event will have to be analyzed to determine if a tsunami has resulted. This area expands as the time from the event increases, so it is important to capture images of the area proximate to the event in a relatively short period after the event occurs. This timing is also important to ensure the earliest possible warning of a tsunami is provided.

In step 225, if a tsunami is indicated by the analyzed images, additional images tracking progress of the tsunami can be taken and analyzed. These images can increase the certainty of the tsunami and can be used to predict landfall times and locations. In step 230, areas affected or potentially affected by the tsunami can be warned by a tsunami warning system. In step 235, appropriate emergency evacuation procedures can be taken. In step 240, additional data can be obtained by tsunameters and other data sources that can be combined with information obtained by analyzing satellite images. Combining data sources can increase tsunami detection accuracy and precision. In step 245, the method can loop to step 225 for a duration of a tsunami, where step 225 continues to take images to track the tsunami.

It should be noted, that the warning system of step 230 and/or emergency evacuation procedures of step 235 can be delayed until a tsunami threat meets or exceeds a previously established threat probability. After a particular tsunami threat, the method can loop from step 245 to step 205, where other water displacement events can be detected. It should be noted that it is possible for method 200 to simultaneously detect multiple water displacement events and to simultaneously track multiple tsunamis.

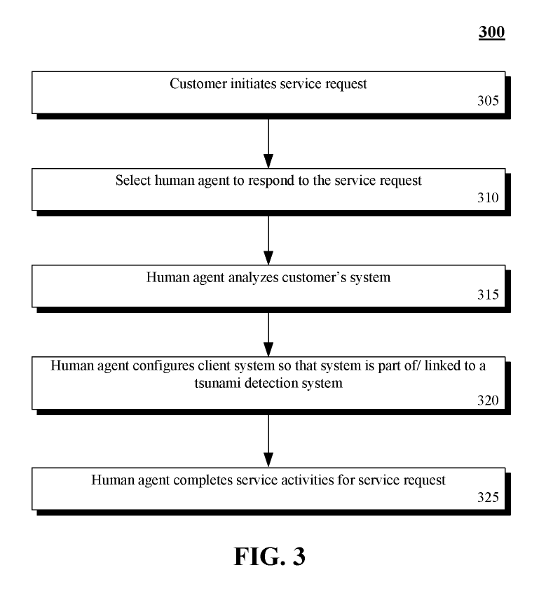

FIG. 3 is a flow chart of a method 300, where a service agent can configure a system that detects and/or tracks tsunamis based upon satellite images in accordance with an embodiment of the inventive arrangements disclosed herein. Method 300 can be preformed in the context of system 100.

Method 300 can begin in step 305, when a customer initiates a service request. The service request can be a request for a service agent to communicatively link an existing Earthquake detection system with a satellite image analysis system for purposes of detecting tsunamis. The service request can also be a request to optimize image analysis software for tsunami detection purposes and/or to integrate an image-based tsunami detection system with a tsunameter based detection system. In step 310, a human agent can be selected to respond to the service request. In step 315, the human agent can analyze a customer's current system and can develop a solution.

In step 320, the human agent can configure the client system so that the system is part of and/or communicatively linked to a tsunami detection system. For example, the human agent can link an emergency response system into the tsunami detection system. In step 325, the human agent can complete the service activities.

It should be noted that while the human agent may physically travel to a location local to adjust the customer's computer or application server, physical travel may be unnecessary. For example, the human agent can use a remote agent to remotely manipulate the customer's computer system.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A method for detecting tsunamis comprising:
detecting a location of a rapid water displacement event occurring in an ocean;
capturing images proximate to the event utilizing a satellite; and
analyzing the captured images to detect a tsunami.

2. The method of claim 1, wherein the detecting step utilizes a seismometer.

3. The method of claim 1, wherein the rapid water displacement event is an underwater Earthquake, and wherein the detecting step utilizes ionosphere disturbances to detect the Earthquake.

4. The method of claim 3, wherein the detection of the ionosphere disturbances occurs before the Earthquake, said method further comprising:
positioning the satellite over a location of the Earthquake before the water displacement event occurs for purposes of capturing images of the event that are analyzed in the analyzing step.

5. The method of claim 1, further comprising:
combining results from the analyzing step with data from at least one tsunameter to increase at least one of a tsunami detection accuracy, a tsunami detection precision, and a warning time for the tsunami.

6. The method of claim 1, further comprising:
combining data from at least one additional source to increase tsunami detection accuracy, wherein said at least one additional source comprises at least one source consisting of eye-witness sighting reports, reports of animal behavioral changes, reports of plant behavioral changes, and reports of atmospheric changes.

7. The method of claim 1, wherein the analyzing step comprises:
ascertaining wave height, wave speed, wave period, and wave direction for the tsunami using the captured images.

8. The method of claim 7, further comprising:
predicting a location and a time that the tsunami will impact a fixed geographical location based on the wave height, wave speed, wave period, and wave direction.

9. The method of claim 8, said predicting step further comprising:
matching topological maps of coastal regions against computer processed tsunami data to predict the location and the time that the tsunami will impact the fixed geographical location.

10. The method of claim 7, further comprising:
continuously tracking movement of the tsunami using time spaced images from at least one satellite.

11. The method of claim 7, further comprising:
predicting tsunami behavior based upon the analyzed images; and
posting a tsunami threat warning based upon the predicted tsunami behavior.

12. The method of claim 7, further comprising:
repositioning at least one satellite for tsunami detection purposes based upon results of at least one of the detecting and analyzing steps.

13. The method of claim 7, wherein the analyzing step further comprises determining a period between consecutive crest passages for the tsunami by analyzing the captured images, wherein an existence of a tsunami is determined when the consecutive crest passages have a period of between ten to thirty minutes.

14. The method of claim 1, wherein the steps of claim 1 are performed by at least one of a service agent and a computing device manipulated by the service agent, the steps being performed in response to a service request.

15. A machine-readable storage having stored thereon, a computer program having a plurality of code sections, said code sections executable by a machine for causing the machine to perform the steps of:
detecting a location of a rapid water displacement event occurring in an ocean;
capturing images proximate to the event utilizing a satellite; and
analyzing the captured images to detect a tsunami.

16. A system for detecting tsunamis comprising:
a rapid water displacement detection system configured to detect an occurrence and a location of events that results in rapid water displacements occurring in an ocean;
a imaging satellite configured to capture images of areas indicated by the detection system responsive to a detected rapid water displacement event; and
an image analyzer configured to analyze the images captured by the imaging satellite, to ascertain wave height, wave speed, and wave direction for waves resulting from the detected rapid water displacement event and to determine an existence of a tsunami based upon the ascertained wave height, wave speed, wave period, and wave direction.

17. The system of claim 16, wherein the rapid water displacement detection system comprises:
a seismometer for detecting underwater Earthquakes.

18. The system of claim 16, wherein the rapid water displacement detection system is configured to detect disturbances in the ionosphere occurring above the ocean.

19. The system of claim 16, further comprising:
at least one tsunameter configured to gather wave data, which is combined with data obtained by the imaging satellite to detect tsunamis.

20. The system of claim 16, further comprising:
a tsunami threat warning system configured to communicate a tsunami warning based upon results of the image analyzer.
